(19) United States
(12) Patent Application Publication
(10) Pub. No.: US 2002/0136482 A1
(43) Pub. Date: Sep. 26, 2002

(54) Optical switch using total internal reflection and a method of switching signals using the same

(76) Inventor: Jingyun Zhang, Upper St. Clair Township, PA (US)

Correspondence Address: Richard L. Byrne, Esq., Webb Ziesenheim Logsdon Orkin & Hanson, 700 Koppers Building, 436 Seventh Avenue, Pittsburgh, PA, 15219, US

(21) Appl. No.: 10/081,911

(22) Filed: Feb. 22, 2002

Related U.S. Application Data
(60) Provisional application No. 60/270,824, filed on Feb. 22, 2001.

(30) Foreign Application Priority Data
Mar. 6, 2001 (CA) 2,339,466

(51) Int. Cl. G02B 6/35; G02F 1/295; G02F 1/29

(52) U.S. Cl. 385/16; 385/8; 359/315

(57) ABSTRACT

An optical switch is disclosed. The optical switch includes an optical signal transmitting electro-optic crystal having at least one first portion and at least one second portion. At least one of these portions is formed from a material which exhibits a change in index refraction upon the application of an electric field and the first and second portions define a switching interface therebetween. A signal source is provided for emitting a signal along an unguided beam path through the crystal, the unguided beam path intersecting the switching interface at an incident angle. An electric field generator is provided for generating an electrical field in at least one of the first and second portions of the crystal with the electrical field causing a change in an index of refraction for at least one of the first and second portions sufficient to create a critical angle at the interface smaller than the incident angle to reflect the signal off the interface. Thus, by switching the electric field generator off and on, the interface switches between being transparent and reflective to the optical signal to alter the unguided beam path through the crystal. A method of switching using such an electro-optic crystal is also disclosed.

### CROSS-REFERENCE TO RELATED APPLICATION

This application claims the benefit of earlier filed U.S. Provisional Application Ser. No. 60/270,824; filed Feb. 22, 2001 entitled “Optical Switch Comprised of Electro-Optic Crystal Based on Total Internal Reflection”.

### FIELD OF THE INVENTION

This invention relates to the field of telecommunications and more particularly to optical-based telecommunications. Most particularly, this invention relates to methods and apparatuses for switching optical signals in optical based telecommunication networks.

### BACKGROUND OF THE INVENTION

Optical signals are becoming more important in telecommunication systems. Network manipulation of optical signals requires optical switches, and optical switch matrices in order to work. Recently significant research and development efforts have been directed to the development of optical switches. One avenue for such research and development has been to investigate ways of manipulating the optical properties of materials to selectively direct or switch optical signals as needed.

Although a number of interesting technological developments have been made, to date there is no adequate solution. Some of these developments utilize Total Internal Reflection (TIR), which refers to the way an optical signal reflects off a surface where there is a change in an index of refraction of material at either or both sides of the surface. Examples of prior art uses of total internal reflection include some of the following.

TIR is Controlled by Bubble Generation

“Optical switch using bubbles”, J. L. Jackel, U.S. Pat. No. 4,988,157, granted on Jan. 29, 1991 teaches an optical switch which is claimed to be particularly useful as a bistable cross-connect matrix. Parallel input waveguides and parallel output waveguides are formed on a substrate at perpendicular angles so as to intersect. A 45° slot is formed across each intersection and is filled with a fluid having a refractive index matching the waveguide material. Electrodes are positioned adjacent the slots and are selectively activated to electrolytically convert the fluid to gaseous bubbles, thereby destroying the index matching across the slot and causing light to be reflected by the slot rather than propagating across the slot. In the presence of a catalyst, a pulse of opposite polarity or of sufficient size and of the same polarity can be used to destroy the bubble.

“Fabrication of a total internal reflection optical switch with vertical fluid fill-holes”, to J. E. Fouquet et al., U.S. Pat. No. 6,055,344 was granted on Apr. 25, 2000, and teaches an optical waveguide switching technique based TIR caused by thermally generated bubbles inside the index matching liquid which enables optical energy switching between waveguide.

While interesting, these bubble generation prior art devices have several notable limitations, including, a low response speed, and the need to contain the fluid. A loss of fluid would lead to switching failure, and thus is not preferred.

TIR is Varied by Mechanical Movement of Index Matching Material

“Optical Switch”, to Hiroshi Terui, et al., U.S. Pat. No. 4,365,862 was granted on Dec. 28, 1982. This teaches a waveguide optical switch where TIR is implemented by a movable dielectric chip with refractive index matching between the substrate and waveguide core.

“Optical switch, and a matrix of such switches”, J. Legrand, U.S. Pat. No. 4,582,391, was granted on Apr. 15, 1986. This patent teaches an optical switch, TIR based, moving member controlled electromagnetically to change water presence.

“Optical switch and Q-switched laser”, A. Chandonnet et al., U.S. Pat. No. 5,444,723, was granted on Aug. 22, 1995. This patent teaches a length of an optical fiber having a core and surrounding cladding is held by a block with a portion of said length having substantially all of is cladding removed on one side of the portion and being exposed, and an index overlay perturbation pad is mounted near and substantially parallel to the portion. A translator moves the pad between a first position in which the pad is sufficiently remote from the portion to allow total internal reflection in the portion and a second position in which the pad is sufficiently close to the portion to allow light to escape from the core.

While interesting, these mechanical movement approaches can fail to achieve adequate switching speeds, and suffer from possible mechanical failure leading to a loss of switching. For these reasons, these mechanical movement designs are less preferred.

TIR is Controlled Through the Change of Index of Refraction by Semiconductor:

“Optical Switch”, to Kunio Tada, U.S. Pat. No. 4,832,430, was granted on May 23, 1989, and teaches electrodes are provided in the vicinity of the switching region of a carrier injection type optical switch, and carriers are removed rapidly through these electrodes when the switch is turned OFF. TIR is controlled through the semiconductor material.

“Integrated total internal reflection optical switch utilizing charge storage in a quantum well”, to G. W. Taylor, et al., U.S. Pat. No. 5,329,137, was granted on Jul. 12, 1994. It teaches an optical switch comprising a heterojunction transistor having a source electrode, a gate, a mesa, and three self-aligned waveguides. A source of optical energy is applied to one of said waveguides, and a total internal reflection is created in the switch by inducing a change in refractive index under the gate by means of a charge applied from the source electrode.

While relatively fast and having no moving parts, such switches are difficult and expensive to fabricate and have limited switching geometries. Thus, such semiconductor type switches are less preferred.

TIR is Controlled Thermally

“Thermally driven optical switch method and apparatus”, to R. R. Hayes, U.S. Pat. No. 5,173,956, was granted on Dec. 22, 1992. It teaches optical switching between two waveguides with a common cladding interguide region by passing a current through the interguide region to heat it and thereby alter its refractive index. By controlling the current optical switching between the two waveguides with TIR on and off can be controlled.

While interesting, thermal transients take time to generate and thus the switch is too slow for most applications.

TIR is Controlled by Incident Optical Power

“Optical switch device”, to W. Chen, U.S. Pat. No. 5,018,842, was granted on May 28, 1991. It teaches an optical power limiter and switch, transparent at low light intensity and opaque at high intensity, is comprised of a pair of right triangular prisms separated by a liquid film whose refractive index changes in response to optical energy turning on or off TIR. However, an intensity dependent switch is not very practical, as one of the desired design criteria of a network is a flat power intensity across the network.

TIR is Varied by Electro-Optically Controlling Poled and Unpoled Region of Crystal

“Low loss optical switch with inducible refractive index boundary and spaced output target”, to W. K. Bischel, et al., U.S. Pat. No. 5,911,018, was granted on Jun. 8, 1999. It teaches an optical waveguide switching technique which is implemented based on TIR caused by electro-optically controlling poled and unpoled region of crystal for the application of optical display. While interesting, this teaches a waveguide limited approach which has limited usefulness.

As shown above: (1) the prior art of using TIR mainly focused on waveguide switches/applications; (2) TIR come with a number of implementing techniques; (3) there is only one patent (U.S. Pat. No. 5,911,018) introducing TIR caused by electro-optically controlling poled and unpoled region of crystal, but for application of optical display. Michikazu Kondo (U.S. Pat. No. 4,618,210, granted on Oct. 21, 1986) teaches “as a TIR switch requires an appreciable angle of intersection to achieve sufficiently low cross-talk, a substantial applied voltage is necessary. Since it usually is difficult to construct a high-voltage and yet high-speed driving circuit, a TIR switch is unsuitable for high-speed switching”.

In other words, the variation of refractive index caused by electro-optically controlling poled and unpoled region of crystal is very small (on the order of 10⁻⁵˜10 ⁻⁴). Thus, electro-optic solutions have not been favoured for optical switches.

One way to make use of the small variation of refractive index is to create a series of structures through electro-optically controlling poled and unpoled regions of a crystal. This approach has been used in a refraction based optical beam scanner, as described in the literature “Thin film electrooptic beam deflector using domain reversal in LiTaO₃” by Q. Chen, Y. Chiu, D. N. Lambeth, T. E. Schlesinger, D. D. Stancil, CTuN63, CLEO'93 Conference Proceedings, pp 196 et. seq., Optical Society of America. There are two patents which describe methods of implementing such optical scanner at different levels: U.S. Pat. No. 4,614,408 and U.S. Pat. No. 5,317,446. The major drawback of using refraction based optical beam scanner in an optical switch is that the maximum switching angle between adjacent channels is about 0.6° for a typical design, and this switching angle is sensitive to the variation of the operating electrical field. In optical scanners, signals may be selectively refracted through multiple poled and unpoled regions to vary the output location of a beam passing through the electro-optic crystal for scanning purposes. Suggestions have been made to use the refraction properties as part of a switch, but refraction of optical signals through electro-optic crystal in general is polarization dependent. As such, both TM and TE components within an optical signal being switched are refracted at different angles, making polarization-independent switching impossible. Alternatively, signal manipulating to split and rotate and combine TM and TE components into one polarization is both lossy and expensive. Thus, refraction is not a preferred switching approach. What is needed is an optical switch that has low insertion losses, can switch independent of polarization and wavelengths, has fast switching speeds, preferably has no moving parts and is of a simple structure.

### SUMMARY OF THE INVENTION

The present invention provides an apparatus and method for optical switching. The present invention comprehends a number of switch formats including, 1×2, 1×3, 1×4, 2×2, or 4×4, or even an N×N. According to the present invention, a 4×4 switch format is comprehended both as a non-blocking cross connection switch matrix or it can be more limited, and implemented in a bulk optical switch form.

According to the present invention, the preferred switch has no moving parts, and can switch at very fast speeds (10 ⁻⁸˜10 ⁻¹⁰ second), since switching is implemented by controlling the conditions of TIR. Another feature of the present invention is that the cross-talk is extremely low and switching is not sensitive to the variation of operating electric field. Depending on the switch format and design approach, an optical switch may be built according to the present invention with simple structure, offer low insertion loss and be wavelength and polarization independent.

According to the invention, a 1×N optical switch of simple structure comprises an input fiber collimator, an electro-optic crystal for beam switching and at least two, or more, output fiber collimators. The input fiber collimator collimates the input beam for propagation in free space (i.e. unguided) through an electro-optic switching crystal which has poled and unpoled portions. At any time, one of the output fiber collimators receives the switched beam in free space and couples it into a corresponding output fiber.

The present invention also comprehends a 2×2 optical switch which comprises two input fiber collimators, an electro-optic crystal for beam switching and two output fiber collimators. The two input fiber collimators collimate the input beams for propagation in free space through the electro-optic crystal which has simple poled and unpoled portions. Each of the two output fiber collimators receives either output beam in free space and couples it into the corresponding fiber, respectively, depending upon the switch state. According to a further aspect of the present invention, the 2×2 switch may include beam separating components, which will enable to overall size of the switch to be reduced significantly.

The switching technique of this invention utilizes TIR. Over a given optical spectrum of interest, namely, one which it is desired to switch, as long as TIR condition is maintained for the longest wavelength, the switch works for all wavelengths, and its switching capability is not sensitive to the variation of operating electric field. Further, a TIR based optical switch can easily achieve 5°˜6° switching angle between adjacent channels for TM waves and 2°˜2.5° switching angle between adjacent channels for both TM and TE waves, and these angles are independent from the variation of the operating electrical field, which relaxes the engineering constraints of an optical switch design in many aspects and make its manufacturing easier.

This invention will be better understood upon reference to the following detailed description in connection with the accompanying drawings.

### BRIEF DESCRIPTION OF THE DRAWINGS

Reference will now be made, by way of example only, to preferred embodiments of the present invention as illustrated in the following Figures:

FIG. 1 is a schematic view of a first embodiment of the present invention of a 1×2 switch comprised of an electro-optic crystal which has a simple poled and unpoled structure, where switching is implemented based on TIR of polarized or unpolarized beam;

FIG. 2 is a schematic view of a second embodiment of the present invention of a 1×3 switch comprised of an electro-optic crystal which has a simple poled and unpoled structure, and where switching is implemented based on TIR of polarized or unpolarized beam;

FIG. 3 is a schematic view of a third embodiment of the present invention of a 1×4 switch comprised of an electro-optic crystal which has a simple poled and unpoled structure, and where switching is implemented based on TIR of polarized or unpolarized beam;

FIG. 4 is a schematic view of a fourth embodiment of the present invention of a 2×2 switch comprised of an electro-optic crystal which has a simple poled and unpoled structure, and where switching is implemented based on TIR of polarized and unpolarized beam;

FIG. 5 is a schematic view of the fifth embodiment of the present invention of a 2×2 switch similar to that of FIG. 4, and which has a shorter axial dimension by means of two beam separating prisms;

FIG. 6 is a schematic view of a sixth embodiment of the present invention of a 4×4 cross connection switch matrix comprised of an electro-optic crystal which has a simple poled and unpoled structure, and where switching is implemented based on TIR of a polarized or an unpolarized beam;

FIG. 7 is a schematic view of a seventh embodiment of the present invention of a 4×4 switch matrix comprised of electro-optic crystal which has a simple poled and unpoled structure, and where switching is implemented based on TIR of a polarized or an unpolarized beam; and

FIG. 8 is a schematic view of an eighth embodiment of the present invention of a 4×4 switch matrix similar to that of FIG. 7, but comprised of four segments of electro-optic crystal instead of two segments.

### DETAILED DESCRIPTION OF THE PREFERRED EMBODIMENTS

In this specification, the following terms shall have the following meanings. Total Internal Reflection, or TIR, shall mean the total reflection of an optical signal back into a portion of a signal transmitting material when it strikes an interface with a material having a lower refractive index, at a glancing angle. Angle of incidence means the angle between a line, normal to an interface and the beam path of the optical signal. The glancing angle and the angle of incidence together equal 90°. A collimated signal is one in which the light rays are parallel, and a collimator is an optical device for making light rays parallel. Free space means any environment where an optical signal is not guided and is thus launched from a guided environment to an unguided one. Optical signal means any form of optical signal, whether in the visible spectrum or not, which is modulated or used to carry information. In the present specification optical signal comprehends all telecommunications bands, covering from 850 nm to 1620 mn, and both DWM and other forms of multiplexed signals. In this specification, the term interface is used, in several contexts. A switching interface means an interface that can change between being transparent and reflective. A domain interface is an interface where the domains are inverted between one side and the other side of an interface and is a preferred form of switching interface. Input/output interfaces refer to input and output surfaces of an electro-optic crystal. A crystal/air interface is typically a non-switching reflective interface.

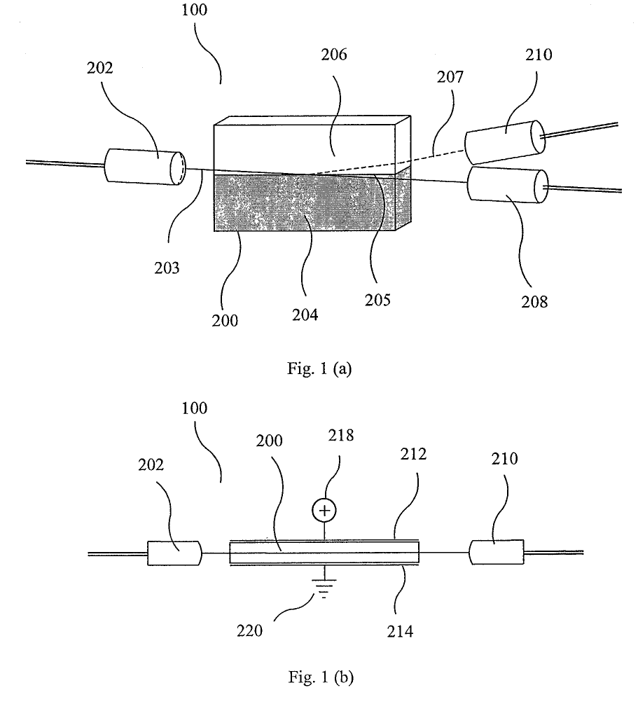

FIG. 1 shows a first embodiment of the present invention, namely, the 1×2 optical switch indicated generally as 100. The switch 100 comprises an input fiber collimator 202, an electro-optic crystal 200, two output fiber collimators 208, 210 and electrodes 212, 214 (not shown in FIG. 1a) on opposite surfaces of crystal 200, which, during switching, are connected to a power source 218 and ground 220. While reference is made to collimators as a preferred form of optical device, it will be understood by those skilled in the art that the present invention comprehends all suitable optical devices for launching the optical signal into free space. Thus, the optical signal source could include a coherent light source (laser), a lens system for focussing the optical signal enough to permit it to traverse the free space unguided signal path portion of the present invention and other like structures. What is comprehended is any form of optical device which can take the optical signal and condition it for efficient passage through free space, through the switching structure as hereinafter described, and then back couple the signal into a waveguide, such as a fiber.

In the preferred form, a signal carrying fiber ends in a collimator, which launches the collimated optical signal into free space through the switch, and then a second or output collimator captures the unguided signal and recouples it to a further fiber. Collimated beams are preferred over convergent or divergent beams, for example, since collimated beams permit simple and easy switch design and makes it easier to achieve TIR conditions.

The electro-optic crystal 200 is preferably made from LiTao₃ or LiNbO₃ or other materials with a high electro-optic coefficient. Although the thickness can be varied, the preferred thickness is around 0.4 to 0.5 mm for the crystal. Inside the crystal, a poled portion 204 interfaces with an unpoled portion 206 at an interface 205. Preferably, 205 is an interface which may be generally parallel to the long edge of the rectangular-shaped crystal, or at a slight angle thereto, depending upon the design criteria. According to the present invention, the material from which the crystal is formed is a ferro electric material which exhibits residual polarization and which can be induced electrically by subjecting the material to a high voltage field. It will be understood that the strength of the electric field required for TIR to take place is directly related to a number of properties of the switch design, including the material selection of electro-optic crystal, the thickness of the poled/unpoled portions and the incident angle of the beam which strikes the interface between the poled/unpoled portions. Thus, the present invention comprehends using sufficient voltage across the switch element to achieve TIR as needed or desired for operation of the switch as herein described. In the specification the term “switching electric field” means a field sufficient to create TIR at an interface having regard to those design properties mentioned above.

In the crystal 200, only one of the grey and the white portions is electrically poled. As a result, the domain directions of the two areas 204 and 206 are opposite. As a linear material, the change of index refraction of Δn may be expressed by the equation

Δn=0.5×n³×r×V/t

where n is the unperturbed refractive index of the crystal, r is the linear electro-optic coefficient, V is the magnitude of the controlling electrical field, and t is the thickness of the crystal. The sign of the electro-optic coefficient, r, and hence the sign of Δn, depend on the direction of the applied electric field relative to the poling direction. These characteristics can be used to maximize the impact of the variation of Δn at a given controlling electric field. The advantage of using poled and unpoled structures within the crystal can now be understood.

Since electro-optic materials tend to be anisotropic, both n and r will be of different values for ordinary beams (s wave) and extraordinary beams (p wave). Usually an extraordinary beam (p wave) exhibits a Δn that is about three times that of an ordinary beam (s wave) under given operating conditions. This implies that TIR is easier to achieve for extraordinary beams (p waves) in terms of operating voltage and the length of the TIR surface. Further, when the TIR requirements are maintained only for extraordinary beams (p wave) the switch according to the present invention is a polarization maintaining switch. If higher operating voltages are applied, or the incident beam's grazing angle is further reduced, so that the TIR surface becomes longer, the TIR requirements are maintained not only for the extraordinary beams (p wave), but also for the ordinary beams (s wave). Thus, the present invention further comprehends a switch that is a polarization independent switch. As will be understood by those skilled in the art, a polarization independent switch is an important advantage for optical signal network switching solutions.

FIG. 1a shows how a collimated beam which is launched from the input collimator 202 enters the crystal 200 along a straight path 203. In the absence of an electric field being applied, the optical beam will pass through and exit the crystal 200 and enters the first output collimator 208 as shown. If there is an electrical field applied through electrodes 212, 214, which is applied in such a way that the white area of the crystal shown in the Figure has a higher refractive index and the grey area of the crystal shown in the Figure has a lower refractive index, and once TIR condition is met, then the beam will be reflected at the interface 205, exit the crystal 200 and propagates along path 207 to enter the second collimator 210. Thus, the interface acts as a switching interface for optical signals. The present invention comprehends applying an electric field to either side of the interface, or more preferably to both sides of the interface, where the domains of the two sides of the interface are inverted. In this manner a greater index change is realized more easily, than if the electric field is applied to only one side of the interface.

According to the present invention, this TIR based switch principle works for both ordinary beams (s wave) and extraordinary beams (p wave). However, the ordinary beams (s wave) in general require a higher voltage of electrical field or a smaller grazing angle and longer TIR surface than the extraordinary beams (p wave). Thus, as long as TIR is achieved for the ordinary beam (s wave), TIR is also set up for the extraordinary beam (p wave). In this manner, the present invention provides a polarization of independent 1×2 optical switch in this embodiment.

The refractive index n is a function of wavelength. For longer wavelengths, the values of n become smaller regardless of the extraordinary beam or ordinary beam. When a stream of wavelengths are launched into the switch, for example from 1520 to 1620 nm of the whole C and L bands, as long as TIR is maintained for the longest wavelength, TIR is also maintained for all shorter wavelengths. Thus, according to the present invention the 1×2 optical switch functions independently from wavelengths. As can now be understood, this is another attractive and important feature of the invention for the application of switching in WDM/DWDM network systems. FIG. 1b shows a top view of the embodiment of FIG. 1a. As can be seen, the electrodes 212,214 are provided on opposite lateral faces to permit the electrical field to be applied across the electro-optic crystal 200 as described above.

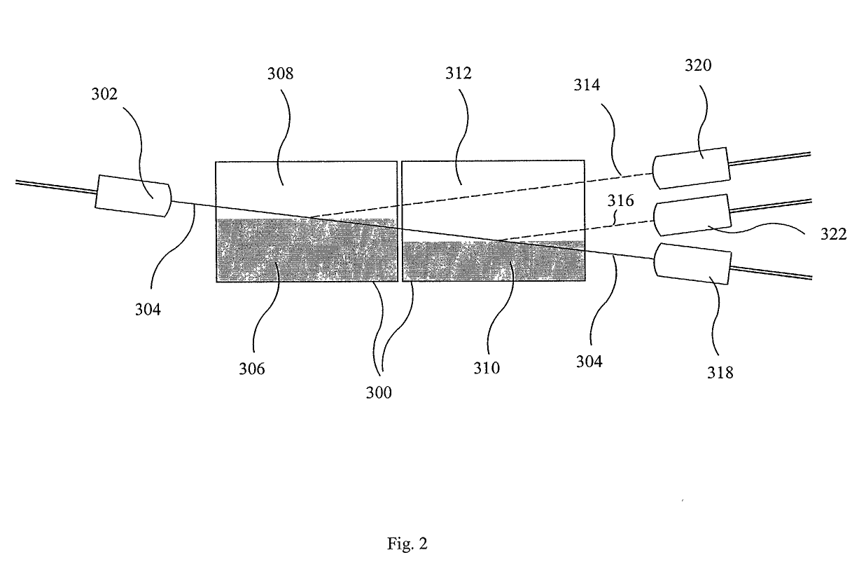

FIG. 2 shows the second embodiment of the present invention which comprises a 1×3 optical switch based on electrical field induced TIR according to the present invention. Thus, as seen, FIG. 2 has an input fiber collimator 302, a piece or body of electro-optic crystal 300, which has four poled and unpoled portions through 306,308,310, and 312 and three output fiber collimators 318, 320, and 322. In this embodiment, the switch controlling electrode (not shown) has two separate sections, one controlling the left crystal body and one controlling the right crystal body. As shown, a collimated beam is emitted from the input collimator 302 along line 304 and enters the crystal 300. At switch position 1, no electric field is applied and the beam will propagate through free space along a straight path within the crystal 300. The signal beam exits the crystal and continues propagation along path 304 until entering the output collimator 318. At switch position 2, a controlling electric field is applied to the left electrode such that TIR is achieved at the interface between areas 306 and 308 of the crystal. Thus, the beam 304 is reflected and propagates along dashed line 314 and enters a second output collimator 320. At switch position 3, the controlling electric field is applied on the right side electrode only, such that TIR is achieved at the interface between areas 310 and 312 where the beam is reflected. Thus, the reflected beam exits along path 316 and enters the third output collimator 322. Again, it will be understood from the foregoing description, where TIR is achieved for ordinary beams (s wave) TIR is also achieved for the all extraordinary beams (p wave) making this switch polarization independent. As well, the TIR achieved for the longest wavelength means that the switch will be wavelength independent.

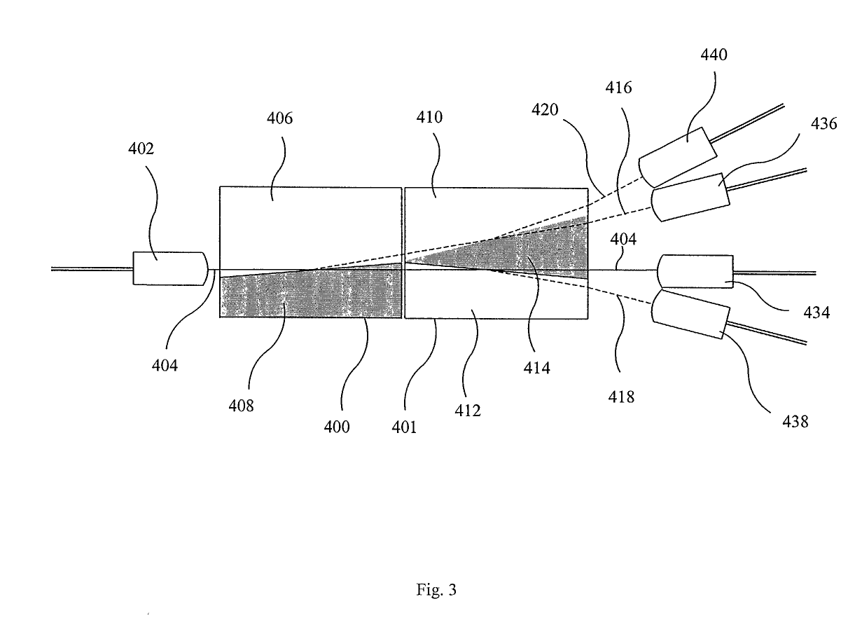

FIG. 3 shows a third embodiment of the present invention which takes the form of a 1×4 optical switch based again on TIR. As shown in FIG. 3, there is an input fiber collimator 402, a first piece of electro-optic crystal 400, a second piece 401 and 5 poled and unpoled sections defined as 406, 408, 410, 412 and 414 to the electro-optic crystal. As well, four output fiber collimators 434, 436, 438 and 440 are provided. Similar to FIG. 2, in this embodiment the switch controlling electrode has two separate sections, one for the left crystal section 400 and one for the right crystal section 401. Thus, a collimated beam exiting from collimator 402 propagates along a straight path 404, and enters the crystal 400, then enters crystal 401, and passes along line 404 until entering output collimator 434. At switch position 2, the controlling electric field is applied to an electrode which generates an electric field in crystal 400 such that TIR is achieved at the interface between the areas 406 and 408, where the beam is reflected off path 404. The reflective beam follows path 416 to enter a second output collimator 436. At switch position 3 a controlling electric field is applied by means of electrodes (not shown) on crystal 401 such that TIR is achieved at the interface of area 412 and 414 where the beam is reflected. The reflected beam exits from the crystal 401 and propagates along path 418 to enter the third output collimator 438. At switch position 4 a controlling electric field is applied on both electrodes creating fields in 400 and 401 such that TIR is achieved at both interfaces between areas 406 and 408, and, 410 and 414 respectively. The signal beam is reflected at both surfaces and thus exits from crystal 401 and propagates along a path 420 to enter the fourth output collimator 440. Again, when TIR is achieved for the ordinary beams (s wave) it is also achieved for the extraordinary beams (p wave). As with the previous embodiments, wavelength independence is also achieved.

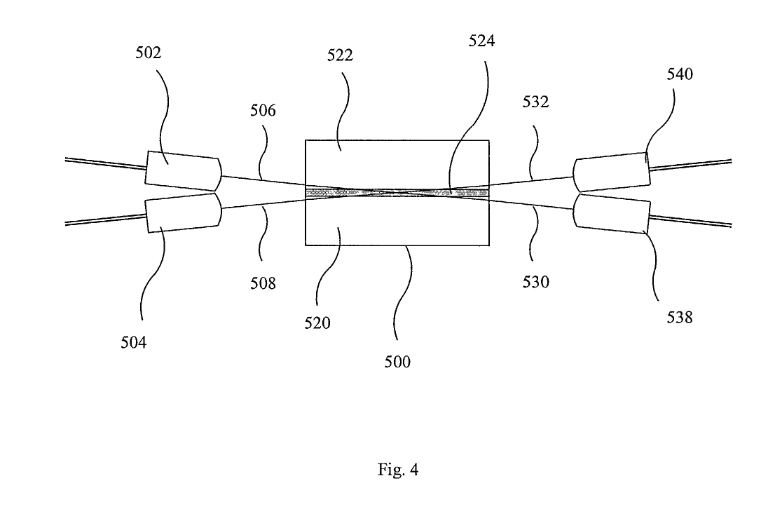

FIG. 4 shows a fourth embodiment of the present invention which takes the form of a 2×2 optical switch. Unlike the previous embodiments, the switch of FIG. 4 has a symmetrical structure. As shown in FIG. 4, two input fiber collimators 502 and 504 are directed towards an electro-optic crystal 500. The optical crystal 500 has a sandwich structure of poled and unpoled portions in which portions 522 and 520 sandwich portion 524 in between. Two output fiber collimators 538 and 540 are also provided. In this embodiment, a switch controlling electrode covers the whole area of 520, 522 and 524. Area 524 is preferably thin in order to minimize beam walk-off as beams are switched. In other words, the greater the thickness of the area 524 the harder it is to align collimators 538 and 540, respectively, with minimum coupling loss for both the transmitted and reflected beams at respective optimum positions. On the other hand, according to the present invention area 524 is thick enough to prevent the two reflective surfaces from such beam leakage caused by evanescent waves at TIR mode as to unacceptably degrade the optical signal.

At switch position one, no electric field is applied. In this instance collimated beam emits from the input collimator 502 propagates along straight path 506 penetrates crystal 500 and propagates along the straight path 530 to enter the first output collimator 538. As well, a collimated beam can also emit from the input collimator 504 propagate along a straight path 508 through crystal 500 and along straight path 532 to enter the second output collimator 540. As shown, the signal paths 508 and 506 cross. However, as long as the two input beams do not have the same coherent light source, interference will not happen, which could otherwise deteriorate the switch performance.

At switch position two, a controlling electric field is applied such that TIR is achieved at the interfaces between area 520 and 524 and area 522 and 524. In this case, the beam from collimator 502 follows path 506 and is reflected to path 532 to enter collimator 540. Similarly, a beam from 504 follows path 508, is reflected off the interface between 520 and 524 and is passed along path 530 to output collimator 538. Again, where TIR is achieved for the ordinary beams (s wave) TIR is also set up for the extraordinary beams (p wave). As well, as previously discussed, wavelength independence is a feature of this switch.

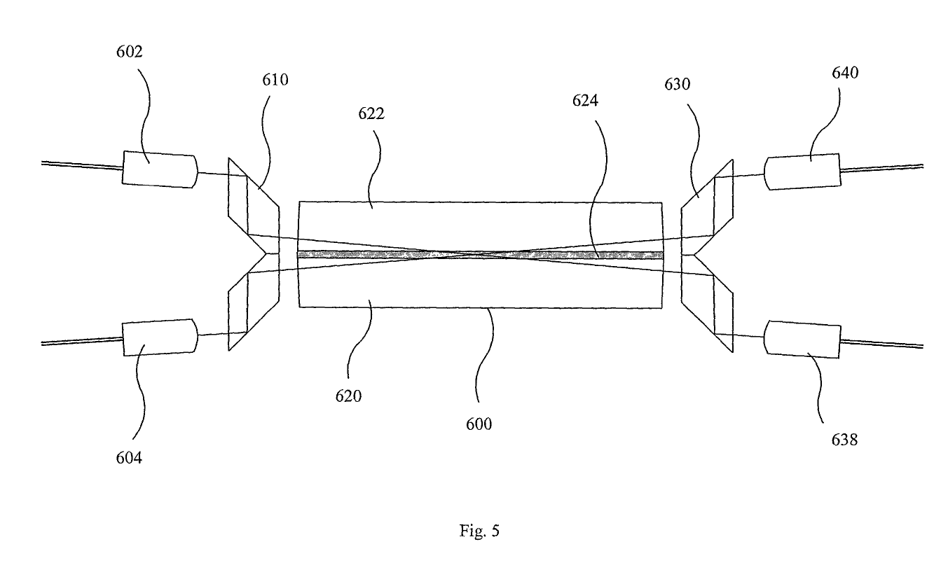

In FIG. 5, a fifth embodiment of the present invention is shown. The beam paths illustrated schematically in FIG. 4 exaggerate the angle between the signal and the interface. As previously indicated, the preferred angle between the signal path and the interface is about 1°. Such a small angle means that input collimators and output collimators need to be either spaced far away from the crystal section so the beams have sufficient line divergence to fit the collimators side by side, or, as shown in FIG. 5, spacers can be used. Thus, FIG. 5 shows a 2×2 optical switch with a symmetrical switching structure, which includes two beam separating prisms. The beam separating prisms allow the axial dimension of the switch to be reduced, because, it is not necessary to provide for enough beam divergence to fit the collimators beside one another. As shown, the embodiment of FIG. 5 includes two input fiber collimators 602 and 604, one beam separating prism 610 at an input end, an electro-optic crystal 600 having the simple sandwich structure of FIG. 4, a beam separating prism 630 at an output end, and two output fiber collimators 638 and 640. In this case, again the switch controlling electrode covers the whole crystal area of 620, 622 and 624.

As can now be understood, at the input and output ends of the crystal 600 both the entrance and exit surfaces are polished with a small −/+ angle that equals the incident beam grazing angles such that beams will not experience any refraction as they enter and exit the crystal 600. This eliminates another kind of beam walkoff between the ordinary beams (s wave) and the extraordinary beams (p wave) which would otherwise lead to additional polarization dependent loss (PDL). According to the present invention, the beam separating angle between the two output channels could be around 1.2°, which is too small to separate the two output beams within short distances. Thus, two beam separating prisms are used to improve the separation. The switching function is fulfilled in the same way as the previous embodiment. Of course, it will be appreciated that the prism shown as 610 is only one form of beam separation that might occur. Any other reflective surface could be used, either singly or in combination to achieve the desired beam path. In the event that collimators 602 and 604 are oriented transversely, only one reflecting surface need be provided. This kind of prism variation also applies to the output end of the electro-optic crystal 600. Furthermore, the idea of beam separating prisms can be applied to the embodiment as shown FIG. 4, where the electro-optic crystal does not have angle-polished input and output surfaces.

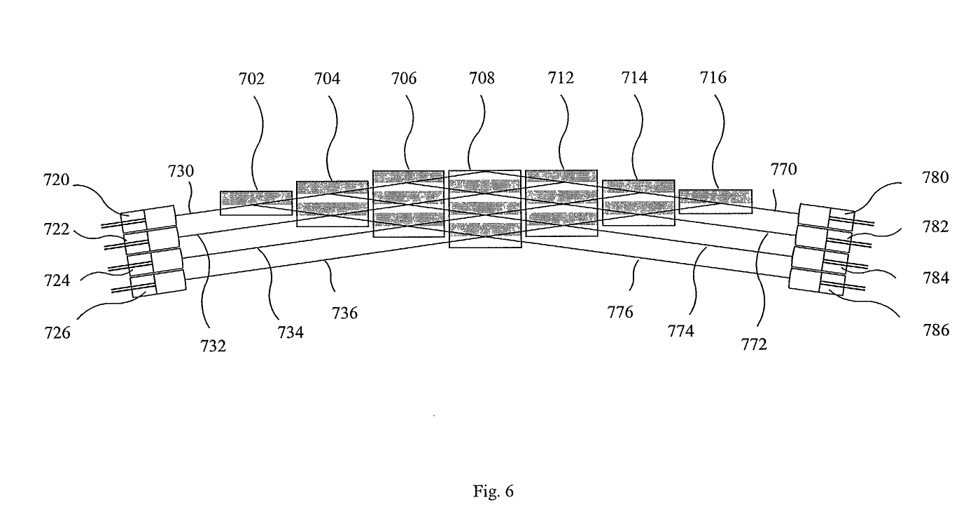

FIG. 6 shows a sixth embodiment of a 4×4 cross-connection switch matrix according to the present invention. As it will now be understood from the foregoing, the embodiment of FIG. 6 operates on the same method as the first embodiment, but with a slightly more complex geometry to suit multiple inputs and outputs. Essentially, what is shown are four fiber input collimators 720, 722, 724 and 726, and seven electro-optic crystal sections 702, 704, 706, 708, 712, 714, and 716. Also shown are four output fiber collimators 780,782,784 and 786. Each of the crystal sections has poled and unpoled portions. There are 15 pairs of switch controlling electrodes, each of them is placed over the interfaces of each of the poled and unpoled sections. Thus, when collimated beams are emitted from the input collimator 720, 722, 724 and 726 and propagate along a straight line path 730, 732, 734 and 736 respectively, they can be selectively reflected at interfaces, to be selectively reflected to each of the output collimators as required. Thus, at any moment, the switch controlling electrodes can be selectively turned on to set up a TIR condition. It can now be appreciated, from FIG. 6, this embodiment permits 24 non-redundant cross-connection combinations between the four input collimators and the four output collimators. This is referred to as a non-blocking 4×4 switch. It will be noted that for beam 730, reflection will occur at the crystal air interface in crystal section 708 to cause reflection to collimator 780 on beam path 770. Thus, with all the switches in 702, 704, 706 in the off position, the beam path is 730 to 770. If any of the switches in 702, 704 and 706 are on, the beam path 730 is reflected to 770 to 774 or 776 respectively.

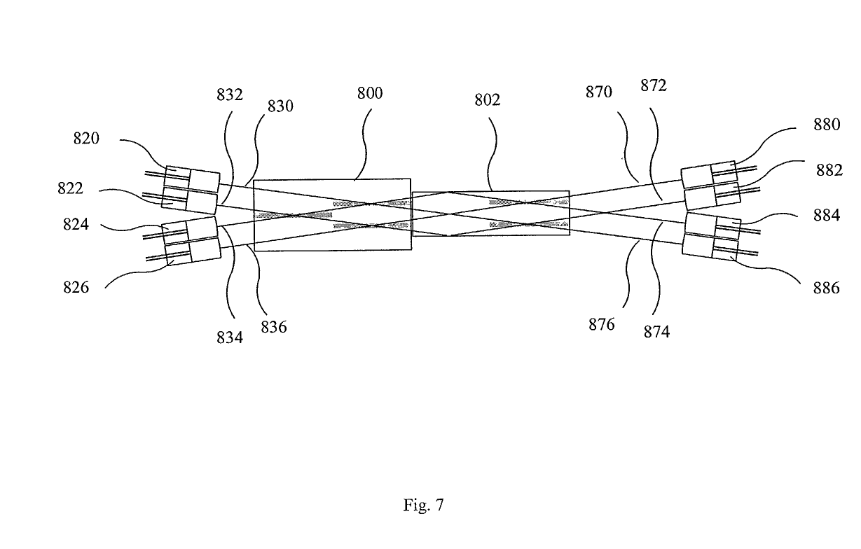

FIG. 7 shows a seventh embodiment of a 4×4 switch matrix according to the present invention, which is based, in part, on the concept disclosed in FIG. 4. In this embodiment, four input collimators 820, 822, 824 and 826 are directed to electro-optic crystal 800, 802. Also provided are four output fiber collimators 880, 882, 884 and 886. As shown the electro-optic crystal 800, 802 have three and two poled and unpoled portions, respectively, each of which functions as a 2×2 switch node. Thus, there are five pairs of switch controlling electrodes and each electrode is placed over one of the 2×2 poled and unpoled sections. In this sense, the 2×2 poled and unpoled sections refers to a sandwich construction as previously described.

Collimated beams are emitted from each of the input collimators 820, 822, 824 and 826 which propagate along straight paths 830, 832, 834 and 836 respectively. Along such beam paths light intersects with the five 2×2 switch nodes and also to air to crystal TIR surfaces. Then, the beams exit the crystal 802 along four output path lines 870, 872, 874 and 876 to enter four output collimators 880, 882, 884 and 886 respectively. At any time, from zero to five pairs of switch controlling electrodes will be turned on to set up a TIR condition. This leads to 24 non-redundant cross-connection combinations between the four input collimators and the four output collimators. As compared to the previous embodiment, it can now be understood that this 4×4 non-blocking configuration has fewer elements and thus less redundancy of switching mechanisms.

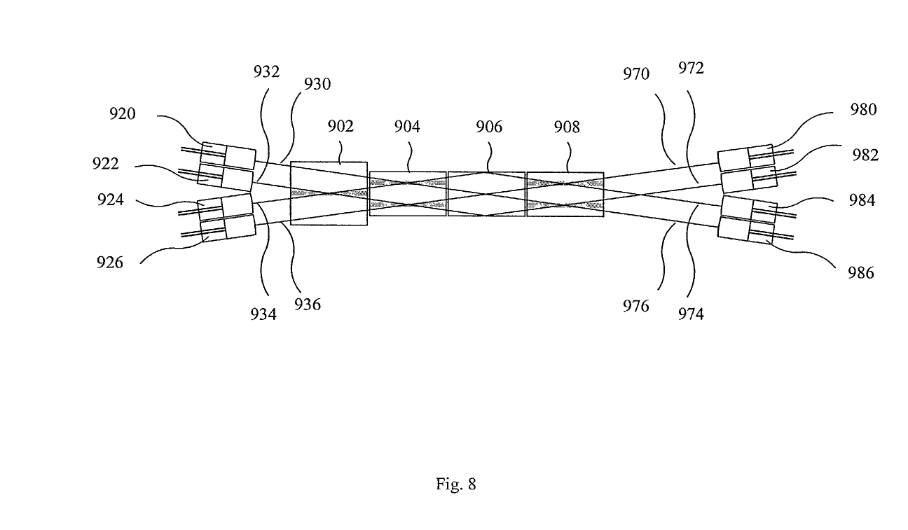

FIG. 8 shows an eighth embodiment of the present invention, in the form of a 4×4 switch matrix. As shown, four input fiber collimators 920, 922, 924, and 926, are directed towards four sections of electro-optic crystal 902, 904, 906 and 908. Also provided are four output fiber collimators 980, 982, 984 and 986. The crystal 902 has one poled and unpoled section, crystal portion 904 and 908 have two poled and unpoled sections respectively. Each of the poled and unpoled portions function as a 2×2 switch node as previously described. In this embodiment, there are preferably five pairs of switch controlling electrodes with one electrode placed over each 2×2 poled and unpoled portions. Collimated beams emit from the input collimator 920, 922, 924, 926 and propagate along a straight path 930, 932, 934 and 936 respectively. Along these four paths light beams intersect with the five 2×2 switch nodes and the two air crystal TIR surfaces as shown and exit the crystal along four output path lines 970, 972, 974, and 976 to enter the four output collimators 980, 982, 984 and 986. Thus, from zero to five pairs of switch controlling electrodes can be turned on to cause TIR conditions which lead to 24 non-redundant cross-connection combinations between the four input collimators and the four output collimators.

Compared to the sixth embodiment, the eighth has fewer pieces of electro-optic crystal. On the other hand, compared to the seventh embodiment, the eighth embodiment has two more pieces of electro-optic crystal. The choice of whether to use fewer or more pieces of crystal will depend upon manufacturing techniques and costs. For example, although more crystal sections are used in the embodiment of FIG. 6, each section is of simple construction. It will be understood that the present invention comprehends both monolithic crystal structures having the poled/unpoled configurations as shown, as well as built-up crystal structures made from one or more discrete crystal sections operatively positioned next to one another. The sixth embodiment, the seventh embodiment and the eighth embodiment all present design approaches for a 4×4 switch matrix, which can possess features of polarization independent switching and wavelength independent switching.

As can now be further understood fabrication of a switch according to the present invention is also simple and easy. The poled/unpoled portions can be separately formed, and then mechanically attached by any appropriate means, such as glue, or the like. Of course, any such fastening cannot interfere with the optical properties along the reflected and unreflected beam paths. Alternatively, a single piece of electro-optic crystal can be modified to form the poled/unpoled portions along an interface by the application of a poling electrode and field.

While the foregoing description has been directed to various preferred forms and embodiments of the invention, the scope of the invention is not limited thereto and extends fully to the scope of the attached claims. Various modifications and alterations are possible to the invention without departing from the broad scope of the claims. Some these modifications have been discussed above, and others will be apparent to those skilled in the art. For example, various geometries are possible which still utilize the same TIR free space switching principles. Thus, the present invention comprehends symmetrical N×N switch configurations as well as non-symmetrical N×M switch configurations.

I claim:

1. An optical switch comprising:
an optical signal transmitting electro-optic crystal having at least one first portion, and at least one second portion, at least one of said portions being formed of a material which exhibits a change in index of refraction upon the application of an electrical field, said first and second portion defining at least one switching interface therebetween;
at least one signal source for emitting a signal along at least one unguided beam path through said crystal, said unguided beam path intersecting said at least one switching interface at an incident angle;
an electric field generator for generating a switching electrical field in at least one of said first and second portions of said crystal, said electric field causing a change in an index of refraction for at least one of said first and second portions sufficient to create a critical angle at said interface smaller than said incident angle to reflect the signal off said interface,
wherein by switching said electric field generator on and off said interface switches between being transparent and reflective to said optical signal to alter said unguided beam path through said crystal.

2. An optical switch as claimed in claim 1 wherein said signal source emits said signal as one or more of a collimated, partially collimated, convergent or divergent signal.

3. An optical switch as claimed in claim 1 wherein the domain orientation of said first portion is inverted relative to the domain orientation of the said second portion.

4. An optical switch as claimed in claim 3 wherein said inverted domains are formed by forming one of said first and second portions as a poled portion.

5. An optical switch as claimed in claim 3 wherein said inverted domains are formed by mechanically coupling together two crystal portions to form said domain interface, wherein one of said crystal portions has an opposite domain orientation to the other.

6. An optical switch as claimed in claims 3, 4 or 5 wherein said electric field generator is sized and shaped to generate said switching electrical field in both said first and said second portions.

7. An optical switch as claimed in claim 3 wherein said switch includes two output collimators and forms a one by two switch.

8. An optical switch as claimed in claim 7 wherein said switch is bidirectional.

9. An optical switch as claimed in claim 3 wherein said first and second portions are sized and shaped to form at least two domain interfaces between said crystal portions.

10. An optical switch as claimed in claims 1 or 3 wherein said change in index of refraction is sufficient to reflect all wavelengths within said signal to provide wavelength independent switching.

11. An optical switch as claimed in claims 1 or 3 wherein said change in index of refraction is sufficient to reflect both TM and TE polarizations within said signal to provide polarization independent switching.

12. An optical switch as claimed in claim 9 further including at least two input collimators wherein said crystal is sized and shaped to permit at least two unguided signal paths to intersect one each of said first and second domain interfaces at said incident angle.

13. An optical switch comprising:
at least one optical signal source of optical signals;
an optical signal transmitting electro-optic crystal defining two switching interfaces, where at each switching interface at least one side of the switching interface is formed of a material which changes an index of refraction upon the application of an electrical field;
said crystal being sized and shaped, and said switching interfaces being sized and positioned to permit at least one unguided beam path through said crystal to intersect one or both of said first and second switching interfaces at an incident angle;
at least one electric field generator for generating a switching electrical field at said switching interfaces, said electric field causing a change in an index of refraction sufficient to create a critical angle at said switching interfaces smaller than said incident angle to reflect said signal off said switching interface, and
at least two optical signal receptors for said optical signal;
wherein by switching said electric field on and off, said switching interfaces switch between being transparent and reflective to said at least one optical signal to alter said unguided beam path through said crystal.

14. An optical switch as claimed in claim 13 including at least three optical signal receptors wherein said two switching interfaces are positioned in said electro optical crystal to permit said signal to follow an unguided unreflected beam path through first one, then the other of said switching interfaces, and to be selectively reflected at neither, or one of said switching interfaces to form a one by three switch.

15. An optical switch as claimed in claim 13 wherein said switch includes at least two input signal generators, each defining an unguided beam path through said crystal and said two switching interfaces are positioned to permit one each of said beam paths to intersect one each of said switching interfaces at said incident angle and to extend to one of said signal receptors and upon the application of an electrical field to define a reflected beam path in which said signal reflects off said switching interface to the other of said optical signal receptors, whereby said optical signals may be passed or reflected to form a two by two switch.

16. The optical switch as claimed in claim 13 wherein said first and second switching interfaces are electrically isolated from one another to permit independent actuation of said index change at each of said switching interfaces.

17. The optical switch as claimed in claim 13 wherein said first and second switching interfaces are not electrically isolated from one another and actuation of said index change occurs at both of said switching interfaces together.

18. An optical switch as claimed in claim 13 wherein one of said two switching interfaces defines a reflected signal path for said beam, and said switch element further includes a third switching interface intersected by said reflected beam path, whereby said signal may be reflected at any one of said three switching interfaces to form a one by four switch.

19. The switch element of claim 18 wherein said first switching interface is electrically isolated from said second and third switching interfaces.

20. An optical switch as claimed in claim 1 or 13 further including one or more optical spacers to permit the axial dimension of the switch to be reduced.

21. An optical switch as claimed in claim 20, wherein said one or more optical spacers comprise at least one reflecting surface.

22. An optical switch as claimed in claim 21 further comprising at least a pair of reflecting surfaces to cause each of said one or more optical signals to be reflected to a beam path spaced apart from said unguided beam path through said crystal.

23. An optical switch as claimed in claim 22 wherein said two reflective surfaces comprise a prism.

24. An optical switch for switching optical signals, said switch comprising:
N input signal sources defining N unguided optical beam paths which do not intersect; where N is two or more;
N output signal sources;
an optical signal transmitting electro-optic crystal having at least enough switching interfaces to reflect each of said unguided optical beam paths to each of said N output collimators, said switching interfaces being positioned to intersect each of said unguided beam paths at an incident angle and being characterized as having a change of index of refraction at said switching interfaces upon the application of an electrical field to create a critical angle less than said incident angle to reflect said signal off said switching interface; and
at least enough electrical field generators for independently generating switching electrical fields for each of said switching interfaces,
to form a non-blocking N by N switch.

25. An optical switch as claimed in claim 24 wherein said electro-optic crystal is a single monolithic structure.

26. An optical switch as claimed in claim 24 wherein said electro-optic crystal is comprised of discrete sections of crystal which are operatively positioned adjacent to one another.

27. An optical switch for switching optical signals, said switch comprising:
four input collimators defining four unguided optical beam paths which intersect;
four output collimators;
an optical signal transmitting electro-optic crystal having at least five switching structures positioned to intersect said unguided beam paths, each of said switching structures having two switching interfaces, each of said unguided beam paths intersecting at least one of said switching interfaces at an incident angle, said switching interfaces being characterized as having a change of index of refraction at said interface upon the application of an electrical field to create a critical angle less than said incident angle to reflect said signal off said switching interface; and
at least five electrical field generators for independently generating switching electrical fields for each of said switching structures for selective reflection of said beam paths, to form a non-blocking four by four switch.

28. An optical switch for switching optical signals, said switch comprising:
N input signal sources defining N unguided optical beam paths which intersect;
N output signal sources;
an optical signal transmitting electro-optic crystal having at least one switching structure positioned to intersect any two of said unguided beam paths, each of said switching structures having two switching interfaces, each of said unguided beam paths intersecting at least one of said switching interfaces at an incident angle, said switching interfaces being characterized as having a change of index of refraction at said interface upon the application of an electrical field to create a critical angle less than said incident angle to reflect said signal off said switching interface; and
at least one electrical field generator for independently generating switching electrical fields for each of said switching structures for selective reflection of optical signals on said beam paths, to form a blocking or non-blocking N by N switch.

29. A non-blocking four by four optical switch for switching optical signals as claimed in claim 27 wherein said four input collimators are arranged in two generally parallel pairs, each of said pairs defining unguided beam paths which intersect with the unguided beam paths of the other pair, and one of said switching structures is positioned in at least three of said intersections.

30. An optical switch comprising:
an optical signal transmitting electro-optic crystal having at least first portion and at least one second portion, at least one of said portions being formed of a material which exhibits a change in an index of refraction upon the application of an electrical field, and being sized and shaped to define at least two switching interfaces between said first and second portions;
at least two signal sources each emitting a signal along a respective unguided beam path through said crystal, each of said unguided beam paths intersecting one of said two switching interfaces at a respective incident angle;
an electrical field generator for generating a switching electrical field in at least one of said first and second portions sufficient to create a critical angle at said interfaces less than said respective incident angles to reflect said signal off said interface;
wherein, by switching said electrical field generator on and off said interfaces switch between being transparent and reflective to said optical signal to alter said unguided beam paths through said crystal.

31. An optical switch as claimed in claim 30 wherein said first portion at least partially surrounds said second portion.

32. An optical switch as claimed in claim 30 wherein said second portion is in the form of a thin strip.

33. An optical switch as claimed in claim 32 wherein said thin strip is thin enough to avoid unacceptable beam walk off and thick enough to have two surfaces reflective enough to switch optical signals upon the application of an electrical field.

34. An optical switch as claimed in claim 33 further including a first pair of generally parallel input collimators defining a first pair of unguided beam paths, and a second pair of input collimators defining a second pair of unguided beam paths, and further includes a first pair of output collimators and a second pair of output collimators, wherein said first pair of unguided beam paths intersect said second pair of unguided beam paths, and said electro-optic crystal includes sufficient thin strip second portions to switch signals from said input collimators to said output collimators.

35. An optical switch comprising:
an optical signal transmitting electro-optic crystal having two first portions, and one second portion, said second portion being formed of a material which exhibits a change in index of refraction upon the application of an electrical field, said first and second portion defining two switching interfaces therebetween;
two signal sources for emitting a signal along unguided beam paths through said crystal, each of said unguided beam paths intersecting at least one of said switching interfaces at an incident angle;
two output signal receptors for receiving said signals;
an electric field generator for generating a switching electrical field in said second portion of said crystal, said electric field causing a change in an index of refraction for said second portion sufficient to create a critical angle at said switching interface less than said incident angle to reflect said signal off said switching interface,
wherein by switching said electric field generator on and off said switching interfaces switch between being transparent and reflective to said signals to reflect said signals from one output signal receptor to the other output receptor.

36. An optical switch comprising:
at least one optical signal source of collimated optical signals;
a first optical signal transmitting electro-optic crystal having at least one first portion, and at least one second portion, at least one of said portions being formed of a material which changes index of refraction upon the application of an electrical field, said first and second portion defining a first switching interface therebetween;
a second optical signal transmitting electro-optic crystal having at least one third portion, and at least one fourth portion, at least one of said portions being formed of a material which changes index of refraction upon the application of an electrical field, said third and forth portion defining a second switching interface therebetween;
at least one unguided beam path through said crystal, said unguided beam path intersecting said first and second switching interfaces at an incident angle;
a separate electric field generator for generating a switching electrical field in at least one of said first and second portions and of said third and forth portions of said crystal, said electric field causing a change in an index of refraction sufficient to create a critical angle at said switching interfaces less than said incident angle to reflect said signal off said switching interface,
three optical signal receptors for said collimated optical signal;
wherein by switching said electric field on and off said switching interfaces switch between being transparent and reflective to said at least one optical signal to alter said unguided beam path through said crystal thereby switching said beam path between said three optical signal receptors.

37. An optical switch as claimed in claim 13, 24 or 28 wherein said signal source emits said signal to form one or more of a collimated, partially collimated, convergent or divergent signal.

38. An optical switch as claimed in claim 13, 24 or 28 wherein said switch is bidirectional.

39. An optical switch as claimed in claims 13, 24 or 28 wherein at least one of said electric field generators is sized and shaped to generate said switching electrical field on both sides of said switching interfaces.

40. An optical switch as claimed in claims 13, 24 and 28 wherein said electro optic crystal includes generally opposed input/output interfaces, and said interfaces are oriented generally perpendicular to said unguided beam paths.

41. An optical switch as claimed in claims 13, 24 and 28 wherein said change in index of refraction is sufficient to reflect all wavelengths within said signal to provide wavelength independent switching.

42. An optical switch as claimed in claims 13, 24 and 28 wherein said change in index of refraction is sufficient to reflect both TM and TE polarizations within said signal to provide polarization independent switching.

43. A method of switching optical signals comprising:
directing an unguided optical signal into an electro-optic crystal;
passing said signal through at least one switching interface, formed between poled and unpoled portions of said crystal, at an angle of incidence;
selectively applying a sufficient electric field to said electro-optic crystal to change states between having no switching interface reflection and having a critical angle smaller than said angle of incidence to selectively pass or reflect said signal at said switching interface and thereby;
switching said signal between two or more signal receptors.

44. A method of fabricating an electro-optic switch element comprising:
forming at least a first input/output interface on an electro-optic crystal;
forming at least a second input/output interface on said electro-optic crystal, said second interface being generally opposed to said first interface; and
modifying at least a portion of said crystal to define a switching interface generally between said first and second input/output interfaces.

45. A method of fabricating an electro-optic switch element as claimed in claim 42 further including the step of forming a second switching interface in said electro-optic crystal.
